(19) United States
(12) Patent Application Publication
(10) Pub. No.: US 2016/0019045 A1
(43) Pub. Date: Jan. 21, 2016

(54) TERMINAL DEVICE

(71) Applicant: GungHo Online Entertainment, Inc., Chiyoda-ku (JP)

(72) Inventors: Kazuki MORISHITA, Chiyoda-ku (JP); Daisuke YAMAMOTO, Chiyoda-ku (JP)

(73) Assignee: GungHo Online Entertainment, Inc., Chiyoda-ku (JP)

(21) Appl. No.: 14/618,228

(22) Filed: Feb. 10, 2015

(30) Foreign Application Priority Data
Jul. 16, 2014 (JP) 2014-146207

(51) Int. Cl. G06F 9/445; H04L 29/08

(52) U.S. Cl. CPC G06F 8/65; H04L 67/10; G06F 8/61

(57) ABSTRACT

(PROBLEM) Provided is a very user-friendly terminal device.

(Solution) A terminal device according to a first embodiment of the present invention comprises a communication unit for communication with a server over a network, and a control unit for controlling execution of a first application in response to an instruction input from a user, wherein the control unit downloads from the server through the communication unit an update program for the first application on the basis of update information of the first application and a program for executing a second application different from the first application, updates the first application, and makes it possible to select whether to execute the updated first application or the second application in response to an instruction input for activating the updated first application.

### CROSS-REFERENCE TO RELATED APPLICATION

This application is based upon and claims priority under 35 U.S.C. §119 to Japanese Patent Application No. 2014-146207 filed on Jul. 16, 2014, entitled “TERMINAL DEVICE”, the entire contents of which are hereby incorporated herein by reference.

### FIELD

The disclosed technology relates to a terminal device that is able to download a program for executing an application and is able to execute the application.

### BACKGROUND

There is known in the art a terminal device capable of installing a plurality of programs for executing applications and is able to execute an application corresponding to a prescribed icon by selecting the icon displayed on a standby screen. This type of terminal device is connected to a network line such as the Internet, and upon receiving a notification pertaining to an update program from a remote server (Patent Reference 1), executes update processing by downloading a program for updating and installing the downloaded program in the terminal device.

### PRIOR ART REFERENCES

### Patent References

Patent Reference 1: Japanese Laid-open Patent Application 2011-081778

### SUMMARY

However, the conventional terminal device is able to download a program for executing the same application as the program for updating upon receiving the notification thereof from the server, but the conventional terminal device is not able to also download a program for executing a different application along with the program for updating. As a result, both programs need to be downloaded separately which is very inconvenient for the user.

Accordingly, a terminal device is provided that is more convenient for a user according to various embodiments of the present invention.

A terminal device according to a first aspect of the embodiment comprises a communication unit for communication with a server over a network, and a control unit for controlling execution of a first application in response to an instruction input from a user, wherein the control unit downloads, from the server through the communication unit, an update program for the first application on the basis of update information of the first application and a program for executing a second application different from the first application, and updates the first application, and makes it possible to select whether to execute the updated first application or the second application in response to an instruction input for activating the updated first application.

A non-transitory computer-readable medium according to another aspect of the embodiment is a non-transitory computer-readable medium in which a computer program characterized in causing a computer to function as a control unit for controlling execution of a first application in response to an instruction input from a user; wherein the control unit downloads, from the server through the communication unit, an update program for the first application on the basis of update information of the first application and a program for executing a second application different from the first application, updates the first application, and makes it possible to select whether to execute the updated first application or the second application in response to an instruction input for activating the updated first application.

A display control method according to another aspect of the embodiment is a method for controlling execution of a first application in response to an instruction input from a user comprising a step for downloading, from the server, an update program for the first application on the basis of update information of the first application, and a program for executing a second application different from the first application, and updating the first application; and a step for allowing the selection of the execution of either the updated first application or the second application in response to an instruction input for activating the updated first application.

A more user-friendly terminal device is provided according to various embodiments of the present invention.

### BRIEF DESCRIPTION OF THE DRAWINGS

FIG. 1 is a block diagram illustrating a configuration of a terminal device 100 according to a first embodiment of the present invention.

FIG. 2 is a block diagram illustrating a configuration of a server 200 according to the first embodiment of the present invention.

FIG. 3 is an example of a display image in an application according to the present embodiment.

FIG. 4 is an example of a display image in an application according to the present embodiment.

FIG. 5 is a conceptual illustration of user information stored in the server 200 according to the present embodiment.

FIG. 6 is a conceptual illustration of application information stored in the server 200 according to the present embodiment.

FIG. 7 is a processing sequence carried out between the terminal device 100 and the server 200 according to the present embodiment.

FIG. 8 (FIGS. 8A, 8B, 8C, 8D, 8E, 8F, and 8G) show examples of display images in an application according to the present embodiment.

FIG. 9 (FIGS. 9A, 9B, 9C, 9D, 9E, 9F, and 9G) show examples of display images in an application according to the present embodiment.

FIG. 10 shows examples of display images in an application according to another embodiment.

FIG. 11 shows examples of display images in an application according to another embodiment.

### DETAILED DESCRIPTION

The embodiments of the present invention will be described below with reference to the accompanying drawings. Constituent elements common to the drawings are provided with the same reference numerals.

A terminal device 100 that is able to execute an application according to a first embodiment of the present invention is described below in detail as an example of a terminal device according to the present embodiment.

A portable terminal device capable of wireless communication such as a smartphone is provided as an example of the terminal device, but, as shall be apparent, this example is not provided by way of limitation. That is, the present invention can be applied to a portable device such as a portable game device, a feature phone, a mobile information terminal, a PDA, a wireless controller terminal, or to a desktop personal computer, a laptop personal computer, or an arcade terminal installed in a game center and the like.

Moreover, while examples of specific game applications are described as the applications, but, as shall be apparent, these exmaples are not provided by way of limitation to the present embodiment. That is, the present invention can be applied to various applications such as a spreadsheet application, an email application, a document creation application, a scheduling application, and a map application as examples that can be adapted to a terminal device.

(Configuration of Terminal Device 100)

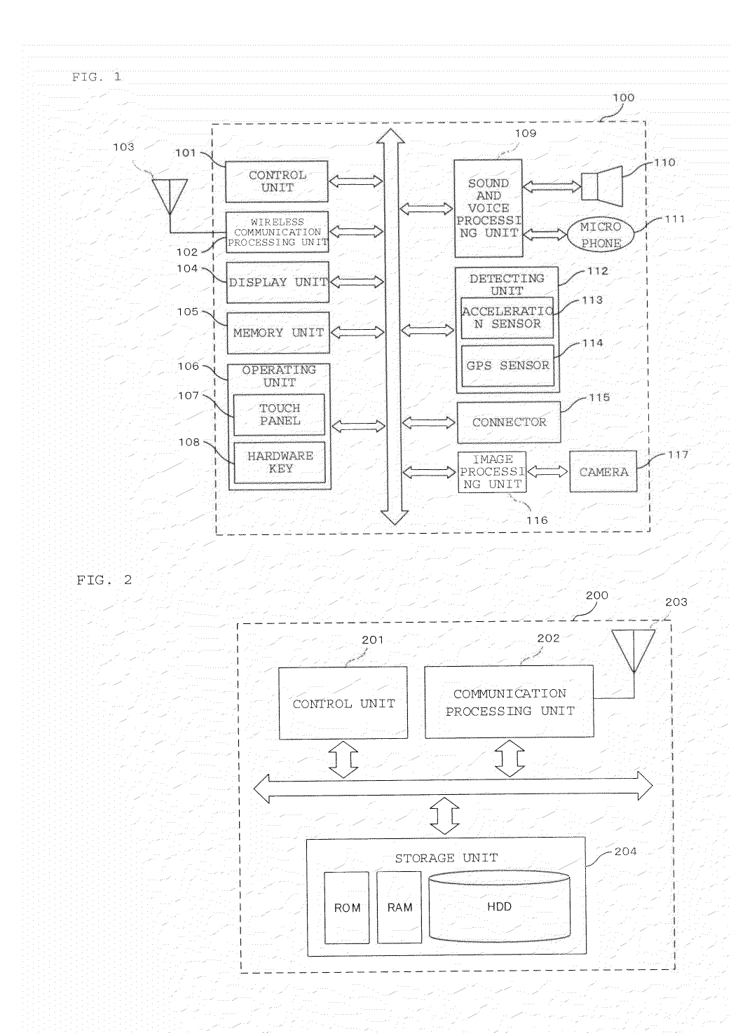

FIG. 1 is a block diagram of a configuration of a terminal device 100 according to the first embodiment of the present invention. The terminal device 100 according to the present embodiment is not necessarily equipped with all of the constituent elements illustrated in FIG. 1 and may have a configuration in which a portion of the constituent elements are omitted.

In reference to FIG. 1, the terminal device 100 according to the first embodiment of the present invention includes a control unit 101, a communication unit configured from a wireless communication processing unit 102 and an antenna 103, a display unit 104, a memory unit 105, an operating unit 106 including a touch panel 107 and hardware keys 108, a sound and voice processing unit 109 connected to a speaker 110 and a microphone 111, a detecting unit 112 including an acceleration sensor 113 and a GPS sensor 114, a connector 115, and an image processing unit 116 connected to a camera 117. The elements are electrically connected to each other through control lines and data lines.

The control unit 101 is configured from a microcomputer (CPU) and controls the display of various types of image information stored in the memory unit 105 on the display unit 104 on the basis of coordinate information inputted according to contact with the touch panel 107. The control unit 101 also reads a program for executing a first application, an update program thereof, and a program for executing a second application stored, the programs being in the memory unit 105, and controls the execution of the applications. The control unit 101 further downloads update programs of the applications from a remotely installed server through the antenna 103 and the wireless communication processing unit 102 on the basis of update information of the applications stored in the memory unit 105, and controls the updating of the first application. The control unit 101 also controls the execution of applications including the first application in response to instruction inputs from a user through the operating unit 106. That is, the control unit 101 controls other connected constituent elements on the basis of various programs stored in the memory unit 105.

The control unit 101 may be configured from a single CPU or may be configured by a plurality of CPUs. A specialized GPU for image processing, that is, for controlling displaying on the display unit 104, may be provided separately.

The communication control unit 102 functions as the communication unit with the wireless communication antenna 103 connected thereto. The communication control unit 102 performs a variety of processes such as modulation and demodulation in order to transmit information stored in the memory unit 105 to another terminal such as a remotely installed server over the network, or in order to receive information transmitted from another device such as a server over the network. For example, when the various programs according to the present embodiment are received from the server, the communication control unit 102 controls the reception of the programs according to the present embodiment from the server altogether at the start of execution or at any time in response to the advance of the processing. The communication control unit 102 also controls the transmission of a variety of processes or results according to the execution of the programs, to the server.

The communication control unit 102 is processed on the basis of a wideband wireless communication protocol as exemplified by wideband-code division multiple access (W-CDMA) protocol, but can also be processed on the basis of a protocol related to narrow-band wireless communication such as wireless LAN or Bluetooth® as represented in IEEE 802.11.

The display unit 104 performs displays as instructed by the control unit 101 that executes prescribed programs on the basis of image information stored in the memory unit 105 for example. Specifically, the display unit 104 performs prescribed displays along with the execution of a first or a second application by the control unit 101. The display unit 104 may be configured from a liquid crystal display as an example. The terminal device according to the present embodiment is provided with a single display unit, but may be provided with two or more display units.

The memory unit 105 is configured from a ROM, a RAM, and a non-volatile memory and stores programs for executing the first application or the second application according to the present embodiment. The ROM is, for example, a memory for storing programs according to the present embodiment. The control unit 101 executes a variety of processes by loading the programs. The RAM is a memory used for writing and reading data while various commands created by the execution of the programs stored in the ROM are being processed by the control unit 101. The non-volatile memory is a memory in which the writing and reading of data are executed due to the execution of the programs, and the written data is saved in the non-volatile memory even after the execution of the programs is finished.

The operating unit 106 is configured from the touch panel 107 and the hardware keys 108, and accepts a variety of instructions from a user.

The touch panel 107 is disposed so as to cover the display unit 104 and outputs, to the control unit 101, data of position coordinates corresponding to the image data displayed by the display unit 104. Known systems such as a resistance membrane system, a capacitive coupling system, an inductive coupling system, or an ultrasonic surface acoustic wave system may be used as the touch panel system. Contact with the touch panel is detected based on a known indicator such as a finger or a stylus pen according to the system being used.

The hardware keys 108 control signals on and off by the physical pressing of a physical switch, and are configured of a power key and a sound volume key and the like. The hardware keys 108 control the on/off of power to the terminal device and the sound volume of background music and the like during the execution of a program. Moreover, functions keys to be used in a game may be installed in addition to pseudo operation keys.

The detecting unit 112 is configured from the acceleration sensor 113 and the GPS sensor 114. The acceleration sensor 113 detects accelerations in three axial directions of the terminal device 100 to detect, for example, the rotation of the terminal device 100. The GPS sensor 114 detects the current position of the terminal device 100 through communication with a plurality of satellites.

The connector 115 mediates the reading and writing by the control unit 101 of programs for executing game applications upon the insertion, for example, of a cartridge or an external storage medium in which the programs are stored. The connector 115 may also include a terminal part for outputting image information to an external display device such as a liquid crystal television.

The sound and voice processing unit 109 encodes sound and voice information inputted from the microphone 111 for storing in the memory unit 105. The sound and voice processing unit 109 decodes sound and voice information such as background music stored in the memory unit 105 and outputs the sound and voice information through the speaker 110.

The image processing unit 116 is connected to the camera 117 and converts images captured by the camera 117 to a data format compatible for saving and saves the images in the memory unit 105.

(Configuration of Server 200)

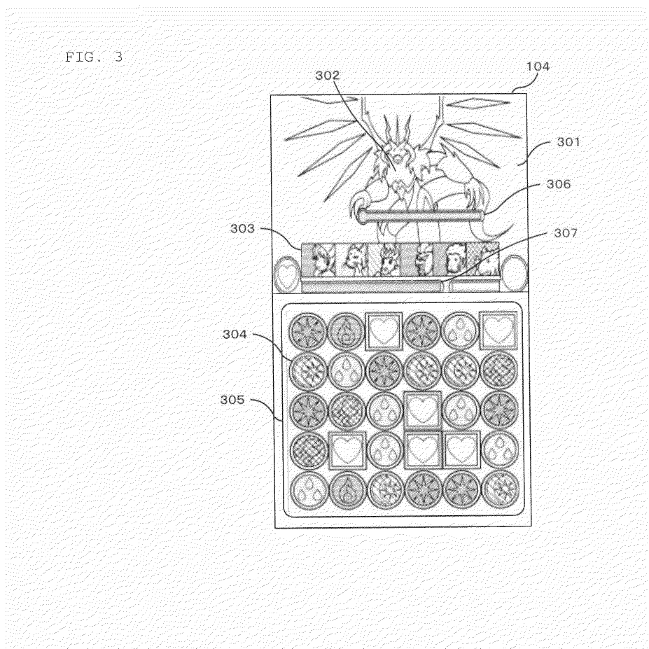

FIG. 2 is a block diagram illustrating a configuration of a server 200 according to the first embodiment of the present invention. The terminal device 200 according to the present embodiment is not necessarily provided with all of the constituent elements illustrated in FIG. 2 and may have a configuration in which a portion of the constituent elements are omitted.

In reference to FIG. 2, the server 200 according to the first embodiment of the present invention includes a control unit 201, a communication unit configured from a communication processing unit 202 and an antenna 203, and a storage unit 204 including a ROM, a RAM, and a hard disk drive (HDD) and the like. The elements are electrically connected to each other through control lines and data lines.

The control unit 201 is typically configured from a CPU and controls the operations of the entire server 200. For example, the control unit 201 authorizes users on the basis of identification information transmitted from the terminal device 100 and controls, upon receiving a request from the terminal device 100, the transmission, to the terminal device 100, of various programs including an update program of the first application and a program for executing the second application.

The communication processing unit 202 performs a variety of processes such as modulating and demodulating for mediating the transmission of various programs and various types of information stored in the storage unit 204 to the terminal device 100 and the reception of various requests and various types of information from the terminal device 100, through the connected wireless communication antenna 203.

The storage unit 204 is configured from a ROM, a RAM, a hard disk drive (HDD) or the like. The ROM stores various programs for enabling controlling by the control unit 201 of the server 200. The RAM is a memory used for writing and reading data while various commands created by the execution of the programs stored in the ROM are being processed by the control unit 201.

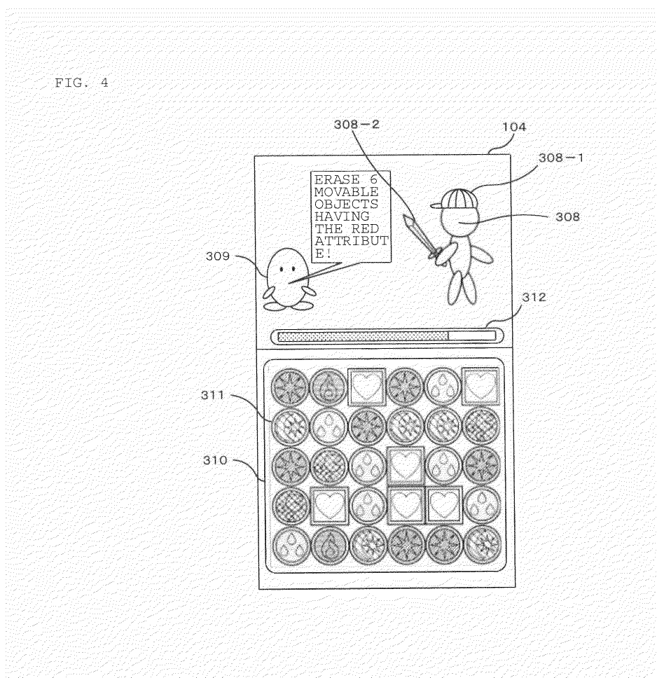

The HDD is a memory for storing results obtained through the execution of programs by the control unit 201, and stores, in addition to the above, user information received from the terminal device 100 as described in FIGS. 3 and 4, and various programs to be transmitted to the terminal device 100 such as the update program for the first application and the program for executing the second application.

The server 200 is described in the present embodiment as being configured from a single device. However, a plurality of servers may be provided according to the functions to be implemented, as shall be apparent. For example, at least two servers are provided, one server authorizing users on the basis of the user information stored in a memory unit and transmitting user information in response to requests from the terminal device 100. In response to a request from the user, the remaining server supplies the update program for the first application or supplies the second application to the terminal device 100.

(Example of First Application)

An application pertaining to a competition-type role playing game is provided as an example of the first application according to the present embodiment. The competition-type role playing game involves acquiring the right to compete in a new dungeon whenever a dungeon configured of a plurality of stages is cleared. The game is completed by repeatedly attempting and clearing new dungeons and clearing all the prepared dungeons.

In this example, a “stage” is an imaginary battlefield for controlling one or a plurality of ally characters stored in association with the user and competing against one or a plurality of enemy characters that appear through the implementation of a puzzle game.

FIG. 3 illustrates examples of display images in an application according to the present embodiment. According to FIG. 3, the display screen of the display unit 104 in the terminal device 100 is divided vertically in two, and an imaginary battlefield 301 is displayed in the upper part of the screen and an enemy character 302 that acts as a match opponent on the battlefield and one or a plurality of ally characters 303 stored in association with the user are displayed. A 5-row by 6-column lattice-shaped board face 305 is further displayed with a plurality of movable objects 304 disposed thereon in the lower part of the screen, and the user is allowed to advance through the puzzle game by controlling the disposition of the movable objects 304 in response to manipulation instructions from the user inputted through the touch panel 107.

The users move each of the movable objects 304 with manipulation instructions through the touch panel 107 to any position on the board face. In this example, prescribed attributes are previously decided for each of the movable objects 304. For example, the six types of attributes are present and include “red”, “green”, “water”, “yellow”, “purple”, and “recovery” attributes. As a result of the movable objects 304 being moved to any position by the user, the enemy character 302 is subjected to an attack with a prescribed attack force due to a prescribed number (for example, three) or more of the movable objects 304 having the same attribute being disposed on the board face consecutively in the vertical or horizontal direction. A residual value of a body strength parameter of the enemy character 302 that is subjected to the attack is reduced. The residual value of the body strength parameter of the enemy character 302 can be seen by referring to an enemy body strength parameter gauge 306.

Conversely, each time the user moves a prescribed number of the movable objects 304, the ally character 303 is subjected to an attack with a prescribed attack force from the enemy character 302. The body strength parameter of the ally character 303 is reduced when subjected to the attack. The residual value of the body strength parameter of the ally character 303 can be seen by referring to an ally body strength parameter gauge 307.

Ultimately, the team that loses all of the body strength parameters first loses the game and the first competitive game is finished. The stage can be cleared by winning this type of competitive game a plurality of times, and the dungeon can be cleared by clearing all of the stages included in the dungeon in the same way.

While one or a plurality of ally characters 303 are configured by characters obtained by winning a competition against the enemy character 302 in the game application according to the present embodiment, one or a plurality of ally characters 303 may be obtained by consuming a prescribed billing item. The “billing item” can be purchased by using currency in the real world from the supplier of the applications according to the present embodiment.

Moreover, a character owned by a user previously registered as a friend may be used in a competitive game against the enemy character 302 as a helper of the one or the plurality of ally characters 303. The registration of friends has a prescribed limit and a maximum of five users, for example, may be previously registered as friends.

(Example of Second Application)

The second application according to the present embodiment is a game application different from the first application, and the program for executing the second application can be obtained by downloading the second application separately from the server. When obtained separately, an activation icon for activating the second application is displayed on the standby screen of the display unit 104 of the terminal device 100 due to the program being installed in the terminal device 100, and the second application can be activated by selecting the activation icon.

In addition to the above obtaining method, the program for executing the second application can be obtained by downloading the program along with the update program for the first application from the server 200 in the present embodiment. In this case, the user selects the activation icon corresponding to the first application displayed on the display unit 104 of the terminal device in the standby screen in order to execute the first application, whereby the display switches to a screen for allowing the selection of the first application and the second application and the second application can be started by selecting the execution of the second application.

An application pertaining to a problem solving-type role playing game is provided as an example of the second application according to the present embodiment. The problem solving-type role playing game involves clearing each scenario configured by a plurality of areas in order to acquire the right to compete in a subsequent new scenario. The game is completed by repeatedly attempting and clearing new scenarios so as to clear all of the prepared scenarios.

Herein, “area” signifies an imaginary space in which a character 308 associated with the user and the enemy character 309 are displayed.

FIG. 4 illustrates examples of display images in an application according to the present embodiment. According to FIG. 4, the display screen of the display unit 104 in the terminal device 100 is divided vertically in two, an imaginary area is displayed in the upper part of the screen and the character 308 associated with the user and the enemy character 309 are displayed.

The second application involves the enemy character 309 presenting a problem required to clear the game. Movable objects 311 on a board face 310 displayed in the lower part of the screen of the display unit 104 are moved in response to manipulation instructions from the user through the touch panel 107 and the user advances through the game by solving the problems.

Prescribed attributes are previously decided for the movable objects 311 and, for example, the six types of attributes include “red”, “green”, “water”, “yellow”, “purple”, and “recovery” attributes. As a result of the movable objects 311 being moved to any position by the user, a prescribed number (for example, three) or more of the movable objects 311 having the same attribute are disposed on the board face consecutively in the vertical or horizontal direction, whereby the movable objects 311 disappear from the board face 310.

When the enemy character 309 presents a problem such as “Erase six movable objects having the “red” attribute!”, the user moves the movable objects 311 to cause the movable objects 311 having the “red” attribute to disappear using the aforementioned method. The game is completed due to the user solving the problem within a prescribed time period, that is, within the remaining time period displayed on a time gauge 312.

A prescribed avatar may be given to the character 308 in the second application according to the present embodiment. In the example in FIG. 4, the character 308 is equipped with a hat avatar 308-1 and a weapon avatar 308-2. The movable objects 311 on the board face 310 may be changed so as to display only movable objects 311 having a specific attribute for example and a time limit for advancing through the game may be delayed in response to the types of avatars being used.

The avatars can be obtained by consuming prescribed billing items. The “billing items” are common to the “billing items” used in the first application according to the present embodiment. That is, the user uses a billing item obtained for the first application and is able to use the billing item for purchasing an avatar for the second application. When the user clears all of the problems presented for each area and clears a prescribed scenario in accordance with the execution of the second application in the present embodiment, the user is able to obtain a billing item as a reward.

Moreover, an avatar owned by a user registered as a friend in the first application can be used in the second application. That is, by using an avatar owned by a user registered as a friend, the user can select an avatar more suited to clearing the problem presented by the enemy character 309. The user executing the second application is able to previously register a friend in the second application in the same way as in the first application. When a prescribed user is registered as a friend in the second application, one of the limited registered friends provided in the first application is consumed.

(User information Stored in Server 200)

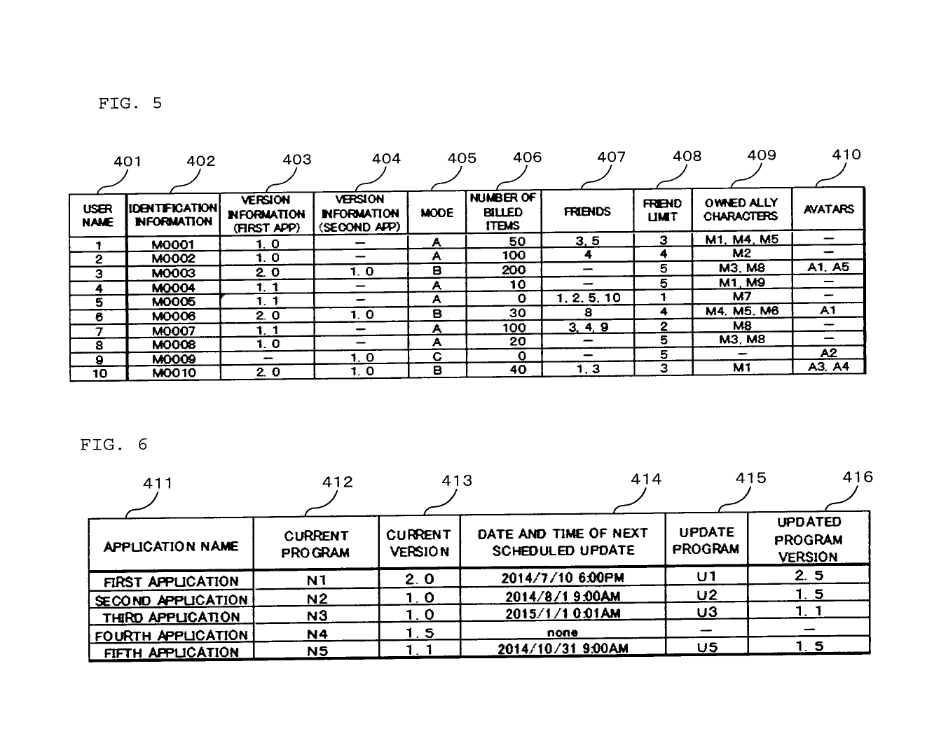

FIG. 5 conceptually illustrates user information stored in the server 200 according to the present embodiment. The user information is transmitted at any time to the terminal device 100 whenever the first or second application is executed in the terminal device 100, and used when executing the applications. The user information is rewritten at any time, accompanying the execution of the applications, on the basis of information transmitted from the terminal device 100.

According to FIG. 5, the HDD in the storage unit 204 of the server 200 stores, in association with each user name 401, identification information (hereinbelow simply referred to as “identification information”) 402 for identifying a user to be supplied when the user installs the first or second application in the terminal device 100; version information 403 of the first application currently installed in the terminal device; version information 404 of the second application currently installed in the terminal device; mode information 405 for indicating whether the first, the second, or both the first and second applications have been executed; number of billed items information 406 indicating the number of billed items owned by the user; user name information 407 of friends previously registered by the user; friend limit information 408 that indicates the remaining number of users that can be registered as friends; ally character information 409 of an ally character owned by the user; and avatar information 410 of an avatar owned by the user. The stored information is transmitted at any time to terminal devices in response to the advance of the applications and is updated in response to the advance of the applications. The stored information is naturally not limited to only the aforementioned information and other information required as appropriate according to the type of application may be stored.

For example, “1.0” is stored as the version information 403 of the first application for a user 1 which indicates that the first application has not been updated. Therefore, this indicates that, since the update program for the version 2.0 which is the latest version of the first application has not been downloaded yet, the second application that is downloaded with the update program has not been installed.

The “mode information 405” is information that indicates whether or not either one or both of the first and second applications has been executed. That is, in the present embodiment, a mode “A” indicates that only the first application has been executed, a mode “B” indicates that both the first and second applications have been executed, and a mode “C” indicates that only the second application has been executed. Consequently, it can be understood whether or not the user has downloaded either of the applications to the terminal owned by the user. Since the mode “A” is stored for the user 1, this fact indicates that only the first application has been executed and the second application has not been downloaded yet to the terminal device of the user 1.

Moreover, “50” is stored as the number of billed items information 406 for the user 1, and the user 1 is able to obtain a new ally character to be used in the first application and to obtain a new avatar to be used in the second application within the scope of 50 billed items.

Moreover, a user 3 and a user 5 are stored as user name information 407 of previously registered friends for the user 1, and the user 1 is able to use the ally characters (M3 or M8) owned by the user 3 or the ally character (M7) owned by the user 5 when executing the first application. The user 1 is also able to use the avatars (A1 or A5) owned by the user 3 when executing the second application. Since the number of users that can be registered as friends is limited to “5” in the present embodiment, the remaining number of users that can be registered as friends by the user 1 in the first application or the second application is “3” (see friend limit information 408).

According to the example of the user 3, the fact the first application has been updated to the version 2.0 already and the second application has been downloaded at the same time as the update, indicates that the second application is also installed in the terminal device. The user 3 has executed both of the applications and thus “B” is stored as the mode information 405.

The description shall now be given using user 9 as an example. The user 9 has not installed the program for executing the first application yet in the terminal device, but has downloaded the program for executing the second application separately from the server and has installed the second application in the terminal device. That is, the program for executing the first application will be downloaded at the time of the subsequent update for the second application, whereby the first application can be executed.

While the first application and the second application are different applications in the present embodiment, a portion of the information is stored in the server 200 and shared in association with a user name and can be referenced by the terminal device 100 while executing both applications. More specifically, the information updated every time the game application advances, that is, the number of billed items information 406, the user name information 407 of registered friends, and the remaining registered friend limit information 408, is used during the execution of either of the first application or the second application. This is because since the billing items, for example, are purchased from the supplier of the applications according to the present embodiment using currency from the real world, it is uneconomical for the user to manage the billing items separately for the first application and the second application. By being able to use the billing items obtained for one of the applications in the other application even though both applications are different, a user who plays one application well can be led to the other application. As a result of being able to use the registered friend user name information 407 and the remaining registered friend limit information 408 between both applications, the relevancy of both applications can be improved in the same way as the billing item information.

(Application Information Stored in Server 200)

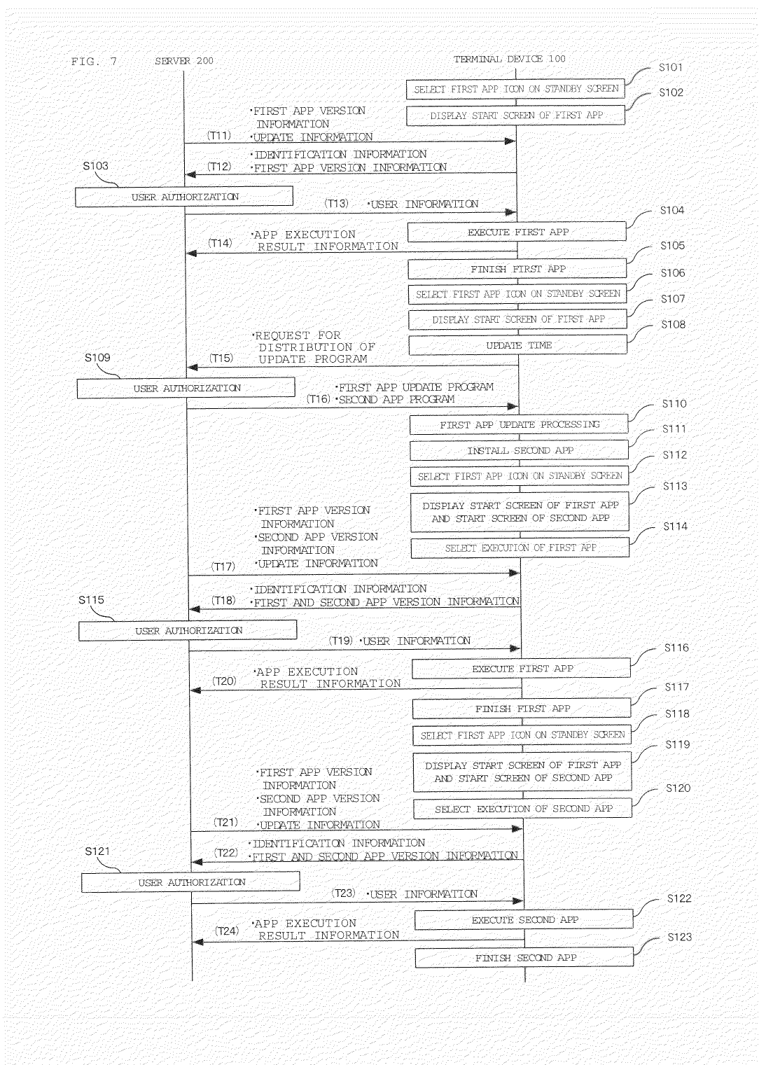

FIG. 6 is a view conceptually illustrating application information stored in the server 200 according to the present embodiment. According to FIG. 6, the storage unit 204 in the server 200 stores, in association with application names 411 that can be distributed to terminal devices, link information 412 of a link to a region in the storage unit 204 in which the programs for executing the application are stored, version information 413 of the application currently being distributed, date and time information 414 of next scheduled updates for the applications, link information 415 of a link to a region in the storage unit 204 in which the programs distributed as the update programs are stored, and version information 416 of the versions after the updating. This information is supplied by the control unit 201 of the server 200 to a terminal device at any time in response to a request from the control unit 101 in each terminal device.

(Processing sequence between terminal device 100 and server 200)

1. Execution of First Application before Update

FIG. 7 illustrates a processing sequence carried out between the terminal device 100 and the server 200 according to the present embodiment. That is, FIG. 7 illustrates a series of steps executed by the control unit 101 of the terminal device 100 and the control unit 201 of the server 200 that starts with the execution of the first application in the terminal device 100, and involves downloading the update program for the first application and the program for executing the second application, and executing the updated first application and the second application.

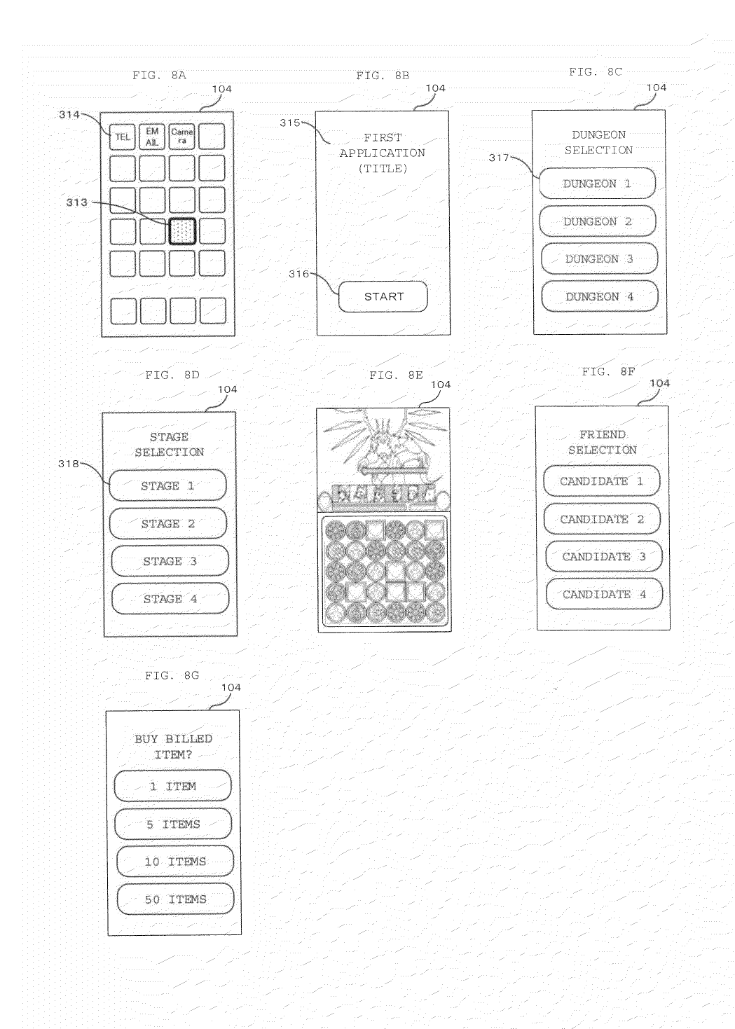

First, the first application is installed in the terminal device 100 according to a previously performed download by the user. The version thereof is either “1.0” or “1.1” in the example in FIG. 5. The processing sequence is started by the control unit 101 due to the selection of the activation icon of the first application displayed in the standby screen while the display unit 104 of the terminal device 100 is displaying the standby screen (S101). As illustrated in FIG. 8A, the “standby screen” in the present embodiment is a screen for displaying a plurality of activation icons 314 in a selectable manner that specify the activation of applications (such as a telephone application, an email application, a camera application and the like) that can be executed by the terminal device 100 in addition to the activation icon 313 for the first application, and is an initial screen that is displayed after a power-up screen or a sleep state release screen and then an authorization screen are displayed for the terminal device 100.

In S101, when the activation icon 313 corresponding to the first application is selected by the user through the touch panel 107 in order to activate the first application, the control unit 101 displays the start screen of the first application as illustrated in FIG. 8B (S102). As illustrated in FIG. 8B, a title 315 of the first application and a start icon 316 for starting communication with the server 200 for executing the first application are displayed on the display unit 104 as an example. At this time, the control unit 101 receives, through the communication control unit 102 and the antenna 103, the current version information 413 of the first application and information pertaining to update information (the presence or absence of the updating schedule and the date and time information 414 of the next scheduled update) from the storage unit 204 of the server 200 (T11), and stores the received information in the memory unit 105 of the terminal device 100. The control unit 101 then transmits, for example, identification information and the version information of the first application program stored in the terminal device 100 to the server 200 (T12).

When the server 200 receives the identification information and the version information of the first application from the terminal device 100, the control unit 201 of the server uses the received identification information to authorize the user of the terminal device 100 (S103). The authorization method may be a known method. While a description is given in the present embodiment of an example of information for identifying a user to be supplied when the user installs the first or second applications in the terminal device 100, a method such as inputting a user ID and a password may be used as an authorization that uses the identification information. Additionally, a unique number (terminal identification number) assigned to each terminal device may be used. When the proper user for the first application is confirmed according to the authorization, the control unit 201 of the server 200 transmits various types of user information required for executing the first application to the terminal device 100 (T13). More specifically, information pertaining to the number of billed items information 406, the user name information 407 of registered friends, the remaining registered friend limit information 408, and the owned character information 409 among the user information stored in the storage unit 204 of the server 200, is transmitted.

The control unit 101 of the terminal device 100 uses the received user information and executes the first application by performing processing based on the program of the first application stored in the memory unit 105 (S104). FIG. 8C illustrates a dungeon selection screen displayed on the display unit 104 accompanying the execution of the first application. The control unit 101 detects an instruction input from the user on a dungeon selection icon 317 through the touch panel 107, and selects the dungeon desired by the user. FIG. 8D illustrates a selection screen displayed on the display unit 104 for selecting a stage included in the selected dungeon. The control unit 101 detects an instruction input from the user on a stage selection icon 318 through the touch panel 107, and selects the stage desired by the user. After passing through the selection of an ally character and a helper character, the display switches to a competitive game screen illustrated in FIG. 8E. The competitive game screen is explained with reference to FIG. 3.

The user is able to obtain new ally characters through the competitive game implemented on the competitive game screen. New information updated in this way is transmitted to the server 200 at any time in response to the advance of the application (T14). The control unit 101 displays another user executing the first application by using another terminal device selected at random by the server 200 as a new candidate friend accompanying the advance of the first application (FIG. 8F). The control unit 101 registers a new friend in response to the desire of the user and transmits the user name information registered as the friend to the server 200. The control unit 101 displays a new purchase screen for billing items accompanying the advance of the first application (FIG. 8G). The control unit 101 selects the number of billing items to be purchased in response to the desire of the user and transmits the information pertaining to the number of selected billing items to the server 200.

When a selection is made to finish the first application that has advanced as described above (S105), the control unit 101 pauses the processing according to the first application until the activation icon 313 corresponding to the first application is selected again on the standby screen.

2. Download of Update Program

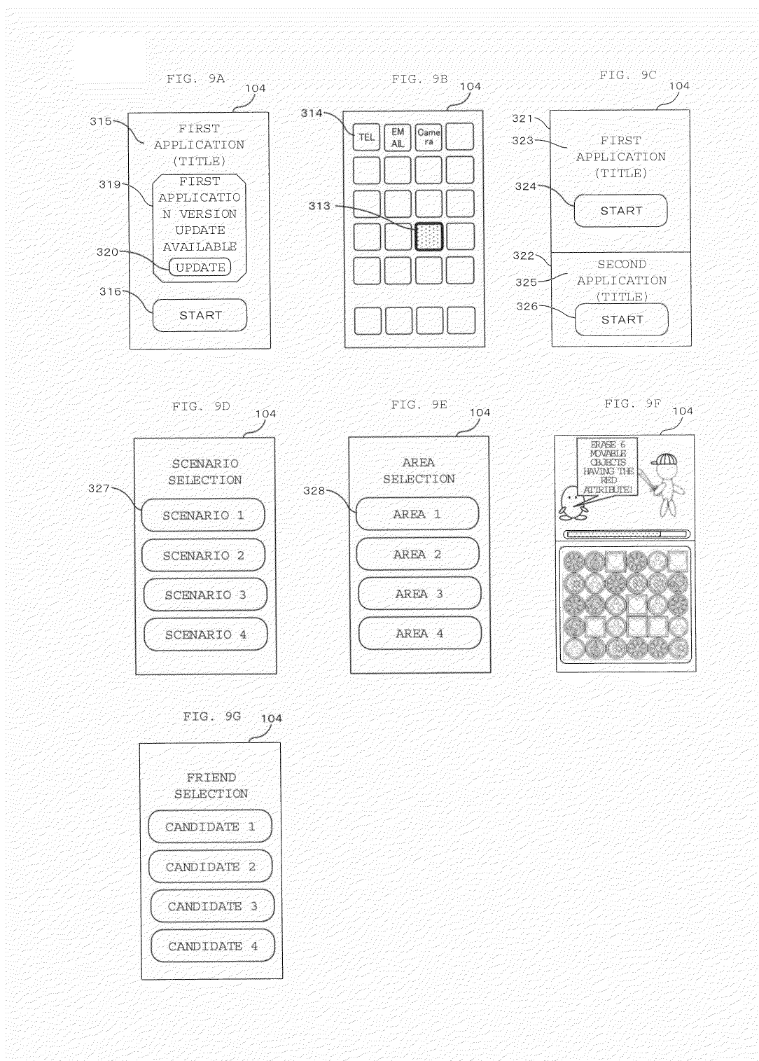

Next, when the control unit 101 detects that the activation icon 313 corresponding to the first application is selected by the user through the touch panel 107 while displaying the standby screen, the control unit 101 activates the first application and displays the start screen of the first application as illustrated in FIG. 8B (S106 and S107). The control unit 101 then refers to the update information (the presence or absence of an update schedule and the date and time information 414 for the next scheduled update) of the first application stored in the memory unit 105 received from the server 200 at T11, and determines whether there is an update and if an update date and time has been reached (S108). If it is determined that the update date and time has not been reached or that there is no update, the control unit 101 performs the processing accompanying the execution of the first application in the same way as the processing in S102 to S105. Conversely, if it is determined that there is an update and the update date and time has been reached already, the control unit 101 provides the display depicted in FIG. 9A on the display unit 104. According to FIG. 9A, a notification 319 that indicates that the update program for the first application has been distributed from the server 200 is displayed on the same start screen of the first application as illustrated in FIG. 8B.

As a result of the detection through the touch panel 107 of the instruction input on an update icon 320 displayed in the notification 319, the control unit 101 in the present embodiment transmits, to the server 200, a distribution request for the update program with the identification information stored in the terminal device 100 in order to start the download of the update program for the first application (T15).

If the instruction input for updating is not performed on the update icon 320 in the present embodiment, it will be impossible for execution of the first application to be continued, so that execution of the first application will be restricted. That is, the control unit 101 forcibly makes the user download the update program for the first application and download the program for the second application. In the prior art, the second application that is different from the first application needs to be downloaded separately. As a result, even though a user enjoys the first application, the new download of the second application is determined according to the inclination of the user. However in the present embodiment, a user who enjoys the first application can be led to use the second application by forcibly making the user download the update program for the first application and download the program for the second application. Therefore, a user who enjoys the first application is able to avoid the trouble of purposefully downloading the second application, and the supplier of the applications is able to lead a user who was acquired by supplying the first application, to the second application, which is convenient for both the user and the supplier.

The control unit 201 of the server 200 that receives the distribution request for the update program at T15, performs authorization to confirm whether the user is a proper user on the basis of the identification information received in S109. Accordingly, when the control unit 201 authorizes the user as the proper user, the control unit 201 refers to the table depicted in FIG. 6 and transmits the update program for the first application and the program for the second application to the terminal device 100 (T16).

The control unit 101 of the terminal device 100 completes the download of the update program for the first application and the program for executing the second application and then performs the processing for updating the first application on the basis of the update program and installs the second application in the terminal device 101 (S110 and S111).

In the present embodiment, “update” signifies the ability to rewrite the entire program for executing the first application before the update to a new program or the ability to rewrite only a portion of the program to be changed. The “update program” may include a program for executing the update processing in addition to the program for executing the application, or may include only the program (or a portion thereof) for executing the application. In the case of the latter, an update processing program shared between applications stored in the terminal device is used, for example, to perform the update processing.

3. Execution of First Application After Update

FIG. 9B depicts the standby screen displayed on the display unit 104 after the update processing for the first application and the installation of the second application has been completed. According to FIG. 9B, the control unit 101 displays the activation icon 313 for the first application on the display unit 104 in the same way as before the update processing of the first application and the installation of the second application. That is in the present embodiment, a separate activation icon for the second application is not displayed on the standby screen and the activation of the second application can be used in combination with the activation icon of the first application regardless of whether the second application that is installed in the terminal device 100 is different from the first application. As a result, the user who has used the first application can be prompted to use the second application.

When an instruction input is detected on the activation icon 313 for the first application by the control unit 101 while the display unit 104 is displaying the standby screen (S112), a start screen 321 for the first application and a start screen 322 for the second application are displayed on the display unit 104 as depicted in FIG. 9C (S113). According to FIG. 9C, a title 322 of the first application and a start icon 324 for starting communication with the server 200 to execute the first application are displayed in the start screen 321 for the first application. A title 325 of the second application and a start icon 326 for starting communication with the server 200 to execute the second application are displayed in the start screen 322 for the second application. That is, the control unit 101 allows the user to select either the execution of the updated first application processing or the execution of the second application, on the display unit 104.

The second application is downloaded and installed along with the update processing for the first application in the present embodiment. Moreover, the start screen 322 for the second application is displayed in response to the instruction input for activating the first application. That is, in a sense, the first application is the “primary” application and the second application is the “secondary” application subordinate to the first application. Therefore, the start screen 321 for the first application previously installed in an executable manner in the terminal device 100 can be displayed on the display unit 104 in a larger manner and the start screen of the second application can be displayed in an identifiable manner so that the user can clearly understand the “primary” and “secondary” relationship.

Next in S114, the control unit 101 selects the execution of the first application when an instruction input on the start icon 324 by the user is detected. As a result, the control unit 101 receives the current version information 413 of the first application, the version information 413 of the second application, and the update information (presence or absence of a scheduled update and the date and time information 414 for the next scheduled update) of both applications from the server 200 and stores the received information in the memory unit 105 (T17). The control unit 101 then transmits, for example, the identification information and the version information of the first and second application programs stored in the terminal device 100 to the server 200 (T18).

Next, when the server 200 receives the identification information and the version information of the first and second applications from the terminal device 100, the control unit 201 of the server 200 uses the received identification information to perform the authorization as to whether the user of the terminal device 100 is the proper user of the first application (S115). When the user is confirmed as the proper user of the first application in S115, the control unit 201 transmits various types of user information required for executing the first application to the terminal device 100 (T19). More specifically, the control unit 201 transmits information pertaining to the number of billed items information 406, the user name information 407 of registered friends, the remaining registered friend limit information 408, and the owned character information 409 among the user information stored in the storage unit 204 of the server 200.

The control unit 101 of the terminal device 100 uses the received user information to execute the first application (S116), and the subsequent processing performed by the control unit 101 until the execution of the first application is finished is the same as described in S104, S105, and T14.

4. Execution of Second Application

While the control unit 101 is waiting while displaying the standby screen on the display unit 104 in S117, the control unit 101 detects an instruction input on the activation icon 313 for the first application (S118), and then displays the start screen 321 for the first application and the start screen 322 for the second on the display unit 104 as depicted in FIG. 9C (S113).

Next in S120, the control unit 101 selects the execution of the second application when the instruction input on the start icon 326 by the user is detected. As a result, the control unit 101 receives the current version information 413 of the first application, the version information 413 of the second application, and the update information (presence or absence of the scheduled update and the date and time information 414 for the next scheduled update) of both applications from the server 200 and stores the received information in the memory unit 105 (T21). The control unit 101 then transmits, for example, the identification information stored in the terminal device 100 and the version information of the first and second application programs stored in the terminal device 100, to the server 200 (T22).

Next, when the server 200 receives the identification information and the version information of the first and second applications from the terminal device 100, the control unit 201 of the server 200 uses the received identification information to perform the authorization as to whether the user of the terminal device 100 is the proper user for the second application (S121). When the user is confirmed as the proper user for the second application in S121, the control unit 201 transmits various types of user information required for executing the second application to the terminal device 100 (T23). More specifically, the control unit 201 transmits information pertaining to the number of billed items information 406, the user name information 407 of registered friends, the remaining registered friend limit information 408, and the owned character information 409 among the user information stored in the storage unit 204 of the server 200. That is, the number of billed items information 406, the user name information 407 of registered friends, and the remaining registered friend limit information 408 among the user information transmitted from the server 200 to the terminal device 100 after the authorization is shared with the first application and also used and shared in the second application.

The control unit 101 of the terminal device 100 uses the received user information and executes the second application by performing processing based on the program for the second application stored in the memory unit 105 (S122). FIG. 9D illustrates a scenario selection screen displayed on the display unit 104 accompanying the execution of the second application. The control unit 101 detects an instruction input from the user on a scenario selection icon 327 through the touch panel 107 and selects the scenario desired by the user. FIG. 9E is a selection screen displayed on the display unit 104 for selecting an area included in the selected scenario. The control unit 101 detects an instruction input from the user on an area selection icon 328 through the touch panel 107 and selects the area desired by the user. Next, after the selection of the avatars to be used, the display switches to the competitive game screen depicted in FIG. 9F. The competitive game screen is explained with reference to FIG. 4.

The user is able to obtain new avatars and billing items through problem-solving games implemented in the competitive game screen. New information updated in this way is transmitted to the server 200 at any time in response to the advance of the application (T24). The control unit 101 displays other users executing the second application using another terminal device selected at random by the server 200 as new candidate friends accompanying the advance of the second application (FIG. 9G). The control unit 101 registers a new friend in response to the desire of the user and transmits the user name information registered as the friend to the server 200.

When a selection is made to finish the second application that has advanced as described above (S123), the control unit 101 pauses the processing according to the first and second applications until the activation icon 313 corresponding to the first application is selected again on the standby screen.

An example in which the updated first application is executed after the update processing for the first application and then the second application is executed is described in the above processing sequence example, but, as shall be apparent, is not provided by way of limitation. That is, after the update processing, the second application may be executed first and then the first application may be executed. Moreover, if the terminal device 100 allows multitasking, the execution of the second application can be started while the first application is being executed, or vice versa.

As described above in the present embodiment, the control unit 101 of the terminal device 100 downloads the program for the second application at the same time as downloading the update program for the first application from the server 200 through the communication units on the basis of the update information obtained from the server after the first application has been activated due to the selection of the activation icon for the first application. Therefore, the user is spared the trouble of separately downloading the second application on purpose.

Moreover, a user who enjoys the first application can be led to use the second application due to the download of the update program for the first application and the download of the program for the second application being forcibly executed, and thus the supplier of the applications is able to lead the user acquired by supplying the first application, to the second application.

Furthermore, the user is allowed to select whether to execute the updated first application or the second application when the activation icon 313 for activating the updated first application is selected and the instruction input for activating the first application is detected. That is, convenience for the user is improved because there is no need to separately provide an activation icon corresponding to the second application provided separately when activating the second application that is different from the first application, and the user can also be led to the second application when activating the first application.

### Other Embodiments

While the activation icon 313 for the first application before the update is used after the update of the first application so that the display switches to the start screen for the first and second applications in the above embodiment, a shared activation icon that is shared for the new activation of the first and second applications may be provided after the update of the first application and the start screens of the first and second applications may be displayed due to an instruction input on the icon.

While the program for the second application is made to be downloaded along with the download of an update program for the first application in the above embodiment, a program for two or more applications may be made to be downloaded. Moreover, while the start screens for the first and second applications are made to be displayed due to the instruction input on the activation icon for the first application after the update processing, a start screen for two or more applications may be displayed in addition to the start screen for the first application.

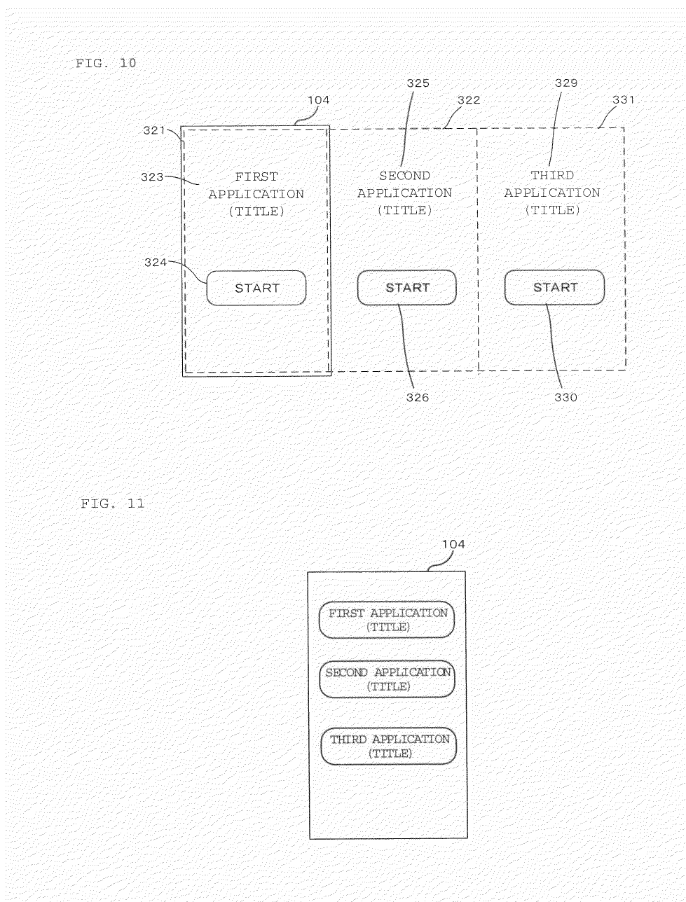

There was provided, in the above embodiment, an example in which the start screen for the first application and the start screen for the second application are displayed vertically within the same screen, but this example, as shall be apparent, is not provided by way of limitation to the method for allowing the first application and the second application to be selected. FIG. 10 illustrates a display example of an example start screen when a program for two or more applications is downloaded along with the download of the update program for the first application, and the start screens 321 and 322 for the respective first and second applications are displayed virtually in a lateral manner and the display screens may be switched in response to a flicking manipulation by a user. The example in FIG. 10 is configured for allowing the selection of a start screen of a third application. Applications that are executable may be displayed in a list as illustrated in FIG. 11, and an application may be selected by the user tapping a corresponding title portion.

While an example in which the server 200 is configured of one device has been described in the above embodiment, a plurality of servers may be provided in accordance with the amount and type of processing. For example, one server may authorize users on the basis of the user information stored in a memory unit and may transmit user information in response to requests from the terminal device 100. The remaining server supplies the update program for the first application and supplies the second application to the terminal device 100 in response to a request from a user. Moreover, a dedicated server for managing billing item information and for purchasing billing items may be provided. In this case, authorization that is performed over the course of the processing is not limited to authorization based on identification information; a user ID and a password may be used as appropriate.

The processing and procedures described in the present specification are merely used for expressly describing the embodiments and may be realized through software, hardware, or a combination thereof. Specifically, the processing and procedures described in the present specification are realized by causing media such as integrated circuits, volatile memory, non-volatile memory, magnetic discs or optical storage to implement logic corresponding to the processing. Moreover, the processing and procedures described in the present specification may be executed by various types of computers by implementing the processing and procedures as computer programs.

While the processing and procedures described in the present specification are described as being executed by single devices, software, components, or modules, the processing or procedures may be implemented by a plurality of devices, a plurality of software, a plurality of components, and/or a plurality of modules. While the data, tables, and databases described in the present specification are described as being stored in a single memory, the data, tables, and databases may be distributed and stored in a plurality of memories in one device or may be distributed and stored in a plurality of memories distributed among a plurality of devices. Moreover, the software and hardware elements described in the present specification may be realized by being integrated into a fewer number of constituent elements or by being divided into a greater number of constituent elements.

### EXPLANATION OF NUMERALS AND CHARACTERS

100 Terminal device
101 Control unit
104 Display unit
107 Touch panel
200 Server

1. A terminal device comprising a communication unit for communicating with a server over a network; and
a control unit for controlling execution of a first application in response to an instruction input from a user;
wherein the control unit downloads, from the server through the communication unit, an update program of the first application on the basis of update information of the first application and a program for executing a second application different from the first application, and updates the first application, and makes it possible to select whether to execute the updated first application or the second application in response to an instruction input for activating the updated first application.

2. The terminal device according to claim 1, wherein
the terminal device comprises a display unit for displaying a prescribed display accompanying the execution of the first or second application; and
the control unit issues a prescribed notification to the display unit on the basis of the update information.

3. The terminal device according to claim 1, wherein
the terminal device comprises a display unit for displaying a prescribed display accompanying the execution of the first or second application; and
the control unit makes it possible to select whether to execute the updated first application or the second application in the display unit in response to an instruction input for activating the updated first application.

4. The terminal device according to claim 1, wherein
the control unit forcibly executes a download of the update program for the first application and a download of the program for executing the second application.

5. The terminal device according to claim 1, wherein
the control unit restricts the execution of the first application until the download of the update program for the first application and the download of the program for executing the second application is performed.

6. The terminal device according to claim 1, wherein
the control unit uses user information stored in the server to control the execution of the first application before and after updating; and uses at least a portion of the user information to control the execution of the second application.

7. The terminal device according to claim 6, wherein
the at least a portion of the user information is a user name and billing item information stored in association with the user name.

8. The terminal device according to claim 7, wherein
the billing item information is information pertaining to a billing item obtained by executing the first application; and the billing item is obtainable by executing the second application.

9. A non-transitory computer-readable medium in which a computer program characterized in causing a computer to function as a control unit for controlling execution of a first application in response to an instruction input from a user; wherein
the control unit downloads, from a server, an update program of the first application on the basis of update information of the first application and a program for executing a second application different from the first application, and updates the first application, and makes it possible to select whether to execute the updated first application or the second application in response to an instruction input for activating the updated first application.

10. A method for controlling execution of a first application in response to an instruction input from a user comprising:
a step for downloading, from a server, an update program of the first application on the basis of update information of the first application and a program for executing a second application different from the first application, and updating the first application; and
a step for allowing the selection of executing either the updated first application or the second application in response to an instruction input for activating the updated first application.
